(19) United States
(12) Patent Application Publication
(10) Pub. No.: US 2015/0249346 A1
(43) Pub. Date: Sep. 3, 2015

(54) WIRELESS POWER RECEIVING DEVICE, WIRELESS POWER SENDING DEVICE, AND WIRELESS POWER TRANSFER SYSTEM

(71) Applicant: Satoshi Shinoda, Nagaokakyo-shi (JP)

(72) Inventor: Satoshi Shinoda, Nagaokakyo-shi (JP)

(21) Appl. No.: 14/645,140

(22) Filed: Mar. 11, 2015

Related U.S. Application Data
(63) Continuation of application No. PCT/JP2013/069000, filed on Jul. 11, 2013.

(30) Foreign Application Priority Data
Oct. 26, 2012 (JP) 2012-236865

(51) Int. Cl. H02J 5/00

(52) U.S. Cl. CPC H02J 5/005

(57) ABSTRACT

A wireless power sending device includes a casing that has a placing surface allowing a wireless power receiving device to be placed thereon and a plurality of recesses arranged in the placing surface in a distributed fashion, a plurality of active electrodes (movable electrodes) that are accommodated in the plural recesses, and that are movable between a first position and a second position in a direction substantially perpendicular to the placing surface, passive electrodes (fixed electrodes) arranged in the recesses of the casing and/or surrounding portions thereof, and a step-up unit (power supply unit) that outputs a first potential and a second potential having a larger absolute value than the first potential. A passive potential is applied to the passive electrodes (fixed electrodes), and an active potential is applied to the active electrodes (movable electrodes) when the active electrodes (movable electrodes) are at the second position.

### CROSS REFERENCE TO RELATED APPLICATIONS

The present application is a continuation of PCT/JP2013/069000 filed Jul. 11, 2013, which claims priority to Japanese Patent Application No. 2012-236865, filed Oct. 26, 2012, the entire contents of each of which are incorporated herein by reference.

### FIELD OF THE INVENTION

The present invention relates to a wireless power receiving device, a wireless power sending device, and a wireless power transfer system each being of electric-field coupling type, which are used to wirelessly transfer electric power.

### BACKGROUND OF THE INVENTION

Recently, a wireless power transfer system has been practiced which wirelessly transfers electric power between itself and an electronic device, e.g., a smartphone or a tablet terminal. Examples of such a wireless power transfer system are disclosed in Patent Documents 1 to 3.

Patent Document 1 discloses a wireless power transfer system of electromagnetic induction type. The disclosed wireless power transfer system of electromagnetic induction type includes a wireless power sending device and a wireless power receiving device. The wireless power sending device includes a power sending coil, and the wireless power receiving device includes a power receiving coil. Electric power is transferred between both the coils through electromagnetic induction.

Patent Document 2 discloses a wireless power transfer system of electric-field coupling type. The disclosed wireless power transfer system of electric-field coupling type includes a wireless power sending device and a wireless power receiving device. The wireless power sending device includes a power sending electrode, and the wireless power receiving device includes a power receiving electrode. Electric power is transferred between both the electrodes through electrostatic induction.

Patent Document 3 discloses, in relation to a wireless power transfer system of electromagnetic induction type, a structure of fitting an electrode of a wireless power sending device and an electrode of a wireless power receiving device to each other.

Patent Document 1: Japanese Patent No. 3344593

Patent Document 2: WO2011/148803

Patent Document 3: Japanese Unexamined Patent Application Publication No. 2006-280173

In the wireless power transfer system of electric-field coupling type, such as disclosed in Patent Document 2, there is a demand for increasing transfer efficiency of electric power and suppressing unwanted radiation of electric fields while widening an allowable range of placement of the wireless power receiving device.

### SUMMARY OF THE INVENTION

An object of the present invention is to provide a wireless power receiving device, a wireless power sending device, and a wireless power transfer system, each being of electric-field coupling type, which can satisfy the demand for increasing the transfer efficiency of electric power and suppressing the unwanted radiation of electric fields while widening an allowable range of placement of the wireless power receiving device.

A first aspect of the present invention provides a wireless power sending device.

The wireless power sending device transfers electric power to a wireless power receiving device with an electric-field coupling scheme.

The wireless power sending device includes:

a casing that has a placing surface allowing the wireless power receiving device to be placed thereon, and that has a plurality of recesses arranged in the placing surface in a distributed fashion;
a plurality of movable electrodes that are accommodated in the plural recesses, and that are movable between a first position and a second position in a direction substantially perpendicular to the placing surface;
a fixed electrode arranged in the recess of the casing and/or a surrounding portion thereof; and a power supply unit that outputs a first potential and a second potential having a larger absolute value than the first potential, wherein the first potential is applied to the fixed electrode, and the second potential is applied to the movable electrodes when the movable electrodes are at the second position.

A second aspect of the present invention provides a wireless power receiving device.

The wireless power receiving device receives electric power transferred from a wireless power sending device with an electric-field coupling scheme.

The wireless power receiving device includes: a casing; and a first electrode and a second electrode, which receive the electric power transferred from the wireless power sending device, wherein a plurality of projections are arranged on a principal surface of the casing in a distributed fashion, the first electrode is arranged in a predetermined portion of the projection, and the second electrode is arranged in the principal surface at a place other than the predetermined portion of the projection.

A third aspect of the present invention provides a wireless power transfer system.

The wireless power transfer system includes a wireless power sending device and a wireless power receiving device that receives electric power transferred from the wireless power sending device with an electric-field coupling scheme.

The wireless power sending device includes: a casing that has a placing surface allowing the wireless power receiving device to be placed thereon, and that has a plurality of recesses arranged in the placing surface and distributed in predetermined positional relation; a plurality of movable electrodes that are accommodated in the plural recesses, and that are movable between a first position and a second position in a direction substantially perpendicular to the placing surface; a fixed electrode arranged in the recess of the casing and/or a surrounding portion thereof; and a power supply unit that outputs a first potential and a second potential having a larger absolute value than the first potential, wherein the first potential is applied to the fixed electrode, and the second potential is applied to the movable electrodes when the movable electrodes are at the second position, and the wireless power receiving device includes: a casing; and a first electrode and a second electrode, which receive the electric power transferred from the wireless power sending device, wherein a plurality of projections are arranged on a principal surface of the casing and distributed in the predetermined positional relation, the first electrode is arranged in a predetermined portion of the projection, and the second electrode is arranged in the principal surface at a place other than the predetermined portion of the projection, wherein the projections of the wireless power receiving device and the recesses of the wireless power sending device are formed in shapes capable of being fitted to each other, and upon fitting of the projections and the recesses, the movable electrode of the wireless power sending device is displaced to the second position by the projection of the wireless power receiving device, the predetermined positional relation is set as positional relation allowing the plural projections of the wireless power receiving device to be fitted to the plural recesses of the wireless power sending device, and when the projections of the wireless power receiving device are fitted to the recesses of the wireless power sending device, the second potential is applied to one of the plural movable electrodes of the wireless power sending device, which one is displaced to the second position.

A fourth aspect of the present invention provides a wireless power sending device.

The wireless power sending device transfers electric power to a wireless power receiving device with an electric-field coupling scheme.

The wireless power sending device includes: a casing that has a placing surface allowing the wireless power receiving device to be placed thereon; a plurality of movable electrodes that are arranged in the placing surface of the casing in a distributed fashion, and that are movable between a first position and a second position in a direction substantially perpendicular to the placing surface; and a power supply unit that outputs a first potential and a second potential having a larger absolute value than the first potential, wherein the first potential is applied to the movable electrode when the movable electrode is at the first position, and the second potential is applied to the movable electrode when the movable electrode is at the second position.

A fifth aspect of the present invention provides a wireless power receiving device.

The wireless power receiving device receives electric power transferred from a wireless power sending device with an electric-field coupling scheme.

The wireless power receiving device includes: a casing; and a first electrode and a second electrode, which receive the electric power transferred from the wireless power sending device, wherein a projection is disposed on a principal surface of the casing, the first electrode is arranged in the projection, and the second electrode is arranged in a portion of the casing other than the projection.

A sixth aspect of the present invention provides a wireless power transfer system.

The wireless power transfer system includes a wireless power sending device and a wireless power receiving device that receives electric power transferred from the wireless power sending device with an electric-field coupling scheme.

The wireless power sending device includes: a casing that has a placing surface allowing the wireless power receiving device to be placed thereon; a plurality of movable electrodes that are arranged in the placing surface of the casing in a distributed fashion, and that are movable between a first position and a second position in a direction substantially perpendicular to the placing surface; and a power supply unit that outputs a first potential and a second potential having a larger absolute value than the first potential, wherein the first potential is applied to the movable electrode when the movable electrode is at the first position, and the second potential is applied to the movable electrode when the movable electrode is at the second position, and the wireless power receiving device includes: a casing; and a first electrode and a second electrode, which receive the electric power transferred from the wireless power sending device, wherein a projection is disposed on a principal surface of the casing, the first electrode is arranged in the projection, and the second electrode is arranged in a portion of the casing other than the projection, wherein, when the wireless power receiving device is placed on the placing surface of the wireless power sending device, one of the plural movable electrodes of the wireless power sending device, that one being positioned in a region of the placing surface opposing to the projection of the wireless power receiving device, is displaced to the second position.

With the present invention, in the wireless power receiving device, the wireless power sending device, and the wireless power transfer system each being of electric-field coupling type, an increase in the transfer efficiency of electric power and suppression of the unwanted radiation of electric fields can be realized while the allowable range of placement of the wireless power receiving device is widened.

### BRIEF DESCRIPTION OF DRAWINGS

FIG. 1 is a block diagram illustrating a configuration of a wireless power transfer system according to a first embodiment.

FIG. 2 is a schematic plan view of the wireless power transfer system according to the first embodiment.

FIG. 3(a) is a sectional view and FIG. 3(b) is a schematic plan view of a wireless power receiving device and a wireless power sending device according to the first embodiment.

FIGS. 4(a) and 4(b) are sectional views illustrating respective structures of a power receiving device-side electrode portion of the wireless power receiving device and a power sending device-side electrode portion of the wireless power sending device according to the first embodiment.

FIGS. 5(a) and 5(b) are sectional views illustrating respective structures of a power receiving device-side electrode portion of a wireless power receiving device and a power sending device-side electrode portion of a wireless power sending device according to a second embodiment.

FIGS. 6(a) and 6(b) are sectional views illustrating respective structures of a power receiving device-side electrode portion of a wireless power receiving device and a power sending device-side electrode portion of a wireless power sending device according to a third embodiment.

FIGS. 7(a) and 7(b) are sectional views illustrating respective structures of a power receiving device-side electrode portion of a wireless power receiving device and a power sending device-side electrode portion of a wireless power sending device according to a fourth embodiment.

FIGS. 8(a) and 8(b) are sectional views illustrating respective structures of a power receiving device-side electrode portion of a wireless power receiving device and a power sending device-side electrode portion of a wireless power sending device according to a fifth embodiment.

FIGS. 9(a) and 9(b) are sectional views illustrating respective structures of a power receiving device-side electrode portion of a wireless power receiving device and a power sending device-side electrode portion of a wireless power sending device according to a sixth embodiment.

FIGS. 10(a) and 10(b) are sectional views illustrating respective structures of a power receiving device-side electrode portion of a wireless power receiving device and a power sending device-side electrode portion of a wireless power sending device according to a seventh embodiment.

FIGS. 11(a) and 11(b) are sectional views illustrating respective structures of a power receiving device-side electrode portion of a wireless power receiving device and a power sending device-side electrode portion of a wireless power sending device according to an eighth embodiment.

FIG. 12 is a block diagram illustrating a configuration of a wireless power transfer system according to a ninth embodiment.

FIGS. 13(a) and 13(b) are sectional views and FIG. 13(c) is a plan view illustrating respective structures of a power receiving device-side electrode portion of a wireless power receiving device and a power sending device-side electrode portion of a wireless power sending device according to the ninth embodiment.

FIGS. 14(a) and 14(b) are sectional views and FIG. 14(c) is a plan view illustrating respective structures of a power receiving device-side electrode portion of a wireless power receiving device and a power sending device-side electrode portion of a wireless power sending device according to a tenth embodiment.

### DETAILED DESCRIPTION OF THE EXEMPLARY EMBODIMENTS

### First Embodiment

A wireless power transfer system according to a first embodiment will be described below with reference to the drawings.

### 1. Configuration

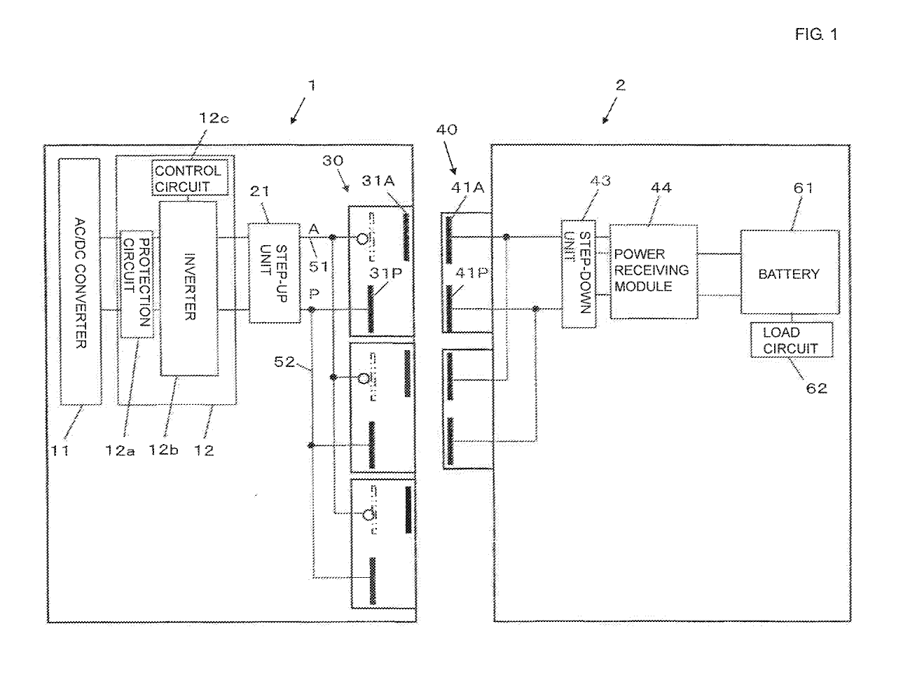

FIG. 1 is a block diagram illustrating a configuration of the wireless power transfer system according to the first embodiment. The wireless power transfer system according to this embodiment is of electric-field coupling type, and it includes a wireless power sending device 1 and a wireless power receiving device 2. The wireless power sending device 1 transfers electric power to the wireless power receiving device 2 through wireless power transfer of electric-field coupling type, and the wireless power receiving device 2 converts the received electric power to a DC voltage and supplies the DC voltage to a battery 61 and a load circuit 62 within the wireless power receiving device.

### 1-1. Configuration of Power Sending Device

The wireless power sending device 1 includes an AC/DC converter 11, a power sending module 12, a step-up unit 21, and a plurality of power sending device-side electrode portions 30.

The AC/DC converter 11 converts an AC voltage input from a commercial power supply, for example, to a DC voltage of a predetermined voltage value. The predetermined voltage value is, e.g., 10 V to 20 V. A battery charged with an output of the AC/DC converter 11 may be disposed on the secondary side of the AC/DC converter 11 and on the primary side of the power sending module 12. With the provision of the battery, electric power can be sent from the wireless power sending device 1 even when the commercial power supply is not available.

The power sending module 12 includes a protection circuit 12a, an inverter 12b, and a control circuit 12c.

The protection circuit 12a cuts off the connection between the AC/DC converter 11 and the inverter 12b when there occurs an overcurrent or an overvoltage, for example.

The inverter 12b converts the DC voltage from the AC/DC converter 11 to an AC voltage of a predetermined voltage value and a predetermined frequency. The predetermined voltage value is, e.g., 10 V to 20 V, and the predetermined frequency is, e.g., 10 kHz to several tens MHz.

The control circuit 12c controls operations of the power sending module 12 and so on.

The step-up unit 21 steps up the AC voltage output from the inverter 12b of the power sending module 12. The step-up unit 21 is constituted by, e.g., a step-up transformer. A voltage after being stepped up by the step-up unit 21 is, e.g., 100 V to 10 kV. A passive potential is output from one end of an output portion of the step-up unit 21, and an active potential higher than the passive potential is output from the other end of the output portion.

Each of the power sending device-side electrode portions 30 includes a power sending device-side passive electrode 31P and a power sending device-side active electrode 31A. The power sending device-side active electrode 31A is constituted as a movable electrode as described later.

The voltage stepped up by the step-up unit 21 is applied between the power sending device-side passive electrode 31P and the power sending device-side active electrode 31A of the power sending device-side electrode portion 30. The passive potential is applied (imparted) to the power sending device-side passive electrode 31P, and the active potential is applied (imparted) to the power sending device-side active electrode 31A. More specifically, the active potential is applied to the power sending device-side active electrode 31A from the step-up unit 21 through an active wiring line 51, and the passive potential is applied to the power sending device-side passive electrode 31P from the step-up unit 21 through a passive wiring line 52. In this respect, the active potential is applied to the power sending device-side active electrode 31A when the power sending device-side active electrode 31A constituted as a movable electrode is brought into contact with the active wiring line 51.

When the power sending device-side passive electrode 31P and the power sending device-side active electrode 31A are in a predetermined opposing state relative to a power receiving device-side passive electrode 41P and a power receiving device-side active electrode 41A (described later) of the wireless power receiving device 2, respectively, a coupling capacitance is generated between the opposing electrodes. With the application of the voltage stepped up by the step-up unit 21 to between the power sending device-side passive electrode 31P and the power sending device-side active electrode 31A in the above-mentioned state, the wireless power sending device 1 transfers electric power to the wireless power receiving device 2 through the electric-field coupling.

The power sending device-side passive electrode 31P and the power sending device-side active electrode 31A are each a metal member in the form of a flat plate.

### 1-2. Configuration of Power Receiving Device

The wireless power receiving device 2 is, e.g., a smartphone, a tablet terminal, or a music player. The wireless power receiving device 2 includes a plurality of power receiving device-side electrode portions 40, a step-down unit 43, a power receiving module 44, a battery 61, and a load circuit 62.

Each of the power receiving device-side electrode portions 40 includes a power receiving device-side passive electrode 41P and a power receiving device-side active electrode 41A. The number of power receiving device-side electrode portions 40 is smaller than the number of the power sending device-side electrode portions 30.

The step-down unit 43 steps down an AC voltage induced between the power receiving device-side passive electrode 41P and the power receiving device-side active electrode 41A (between end portions of later-described lead lines 45A and 45P). The step-down unit 43 is constituted by, e.g., a step-down transformer.

The power receiving module 44 includes a rectifying and smoothing circuit, a DC/DC converter, etc. The rectifying and smoothing circuit rectifies the AC voltage stepped down by the step-down unit 43 into a DC voltage, and then smoothens the DC voltage. The DC/DC converter converts the DC voltage, which has been rectified by the rectifying and smoothing circuit, to a DC voltage adapted for the battery 61 and the load circuit 62.

The battery 61 stores the DC power output from the DC/DC converter of the power receiving module 44, and supplies the DC power to the load circuit 62.

The load circuit 62 executes the predetermined function related to the wireless power receiving device 2.

### 2. Structures of Wireless Power Sending Device and Wireless Power Receiving Device

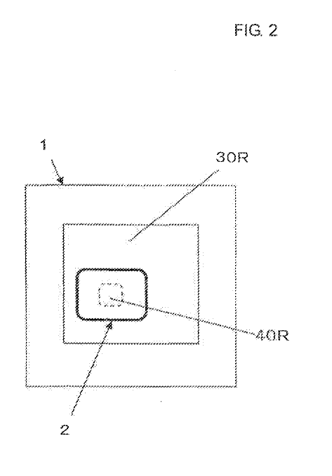

FIG. 2 is a schematic plan view of the wireless power transfer system according to the first embodiment. An area 30R where the power sending device-side electrode portions 30 are disposed in the wireless power sending device 1, which constitutes the wireless power transfer system according to the first embodiment, is larger than an area 40R where the power receiving device-side electrode portions 40 are disposed in the wireless power receiving device 2.

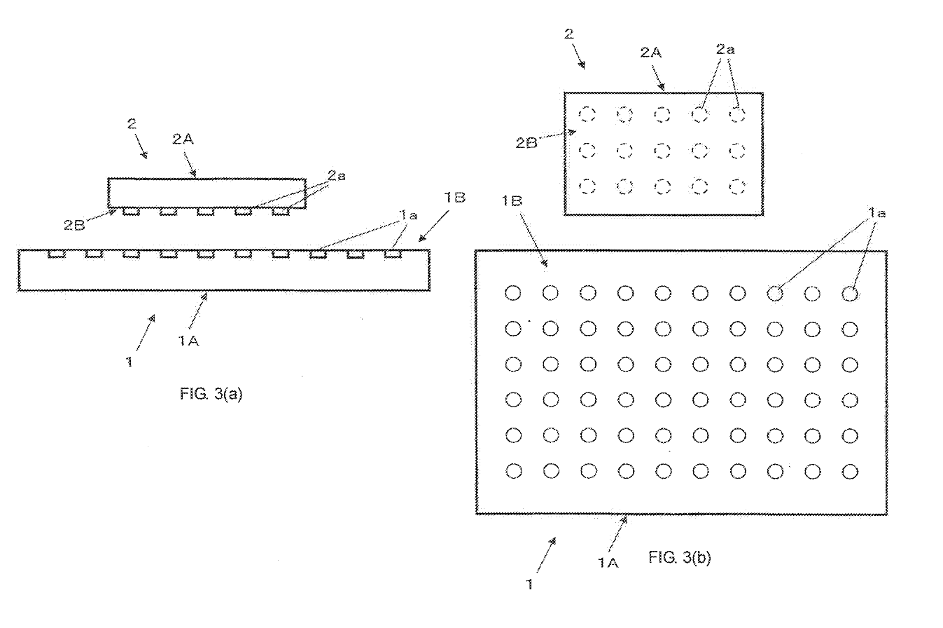

FIG. 3(a) is a sectional view and FIG. 3(b) is a schematic plan view (FIG. 3(b)) of the wireless power receiving device and the wireless power sending device according to the first embodiment.

A casing 1A of the wireless power sending device 1 has a placing surface 1B on which the wireless power receiving device 2 is placed. Plural recesses 1a are formed in the placing surface 1B at equal intervals. The power sending device-side electrode portion 30 is arranged in each of the recesses 1a (as described in detail below). The casing 1A is formed of an insulator, such as resin.

Plural projections 2a are formed at equal intervals on a principal surface 2B of a casing 2A of the wireless power receiving device 2. The power receiving device-side electrode portion 40 is arranged in each of the projections 2a. The casing 2A is formed of an insulator, such as resin.

The interval at which the recesses 1a are arranged in the wireless power sending device 1 is equal to the interval at which the projections 2a are arranged in the wireless power receiving device 2. Furthermore, the recesses 1a of the wireless power sending device 1 have the same shape. The projections 2a of the wireless power receiving device 2 have the same shape. The projections 2a of the wireless power receiving device 2 are formed in the shape capable of being fitted respectively to the recesses 1a of the wireless power sending device 1. Accordingly, when the area where the power receiving device-side electrode portions 40 are disposed in the wireless power receiving device 2 is within the area where the power sending device-side electrode portions 30 are disposed in the wireless power sending device 1, all the power receiving device-side electrode portions 40 in the wireless power receiving device 2 can be each fitted to any one of the power sending device-side electrode portions 30 in the wireless power sending device 1.

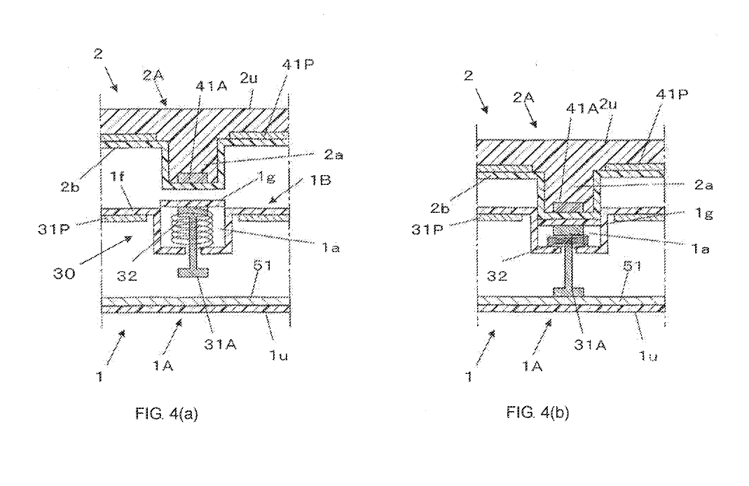

FIGS. 4(a) and 4(b) are sectional views illustrating respective structures of the power receiving device-side electrode portion of the wireless power receiving device and the power sending device-side electrode portion of the wireless power sending device according to the first embodiment. More specifically, FIG. 4(a) represents a state where the projection of the wireless power receiving device and the recess of the wireless power sending device are not fitted to each other, and FIG. 4(b) represents a state where the projection of the wireless power receiving device and the recess of the wireless power sending device are fitted to each other.

As illustrated in FIG. 4(a), the projection 2a of the wireless power receiving device 2 has a cylindrical shape. The power receiving device-side active electrode 41A constituting the power receiving device-side electrode portion 40 is arranged at a lower surface of the cylindrical projection 2a, and the power receiving device-side passive electrode 41P is arranged at a lower surface of a lower side portion 2u of the casing 2A. The casing 2, the power receiving device-side active electrode 41A, and the power receiving device-side passive electrode 41P are covered with an insulator 2b.

The casing 1A of the wireless power sending device 1 has a hollow shape and includes an upper side portion 1f and a lower side portion 1u. The recess 1a is formed in the upper side portion 1f that defines the placing surface 1B of the casing 1A. The recess 1a has such a cylindrical shape allowing the projection 2a of the wireless power receiving device 2 to be fitted to the recess 1a. The power sending device-side active electrode 31A is accommodated in the recess 1a to be movable in a direction perpendicular to the upper side portion 1f (i.e., the placing surface 1B). In other words, the power sending device-side active electrode 31A is constituted as a movable electrode. The power sending device-side active electrode 31A has an I-like sectional shape. A spring 32 is disposed between an upper end portion of the power sending device-side active electrode 31A and a bottom surface of the recess 1a to bias the power sending device-side active electrode 31A upwards such that the upper end portion of the power sending device-side active electrode 31A is positioned substantially at the same level as a reference surface provided by the upper side portion 1f. The power sending device-side active electrode 31A is movable between a first position (i.e., a position to which the power sending device-side active electrode 31A is biased by the spring 32) and a second position (i.e., a position at which a lower end portion of the power sending device-side active electrode 31A is stopped upon touching against the active wiring line 51 described later).

An insulator 1g is attached to an upper surface of the upper end portion of the power sending device-side active electrode 31A. The insulator has a predetermined thickness.

The power sending device-side passive electrode 31P is disposed at the lower surface of the upper side portion 1f of the casing 1A.

The active wiring line 51 is disposed on an upper surface of the lower side portion 1u of the casing 1A of the wireless power sending device 1. The active wiring line 51 is not covered with a coating or the like, and its metal surface is exposed. The voltage stepped up by the step-up unit 21 is applied to the active wiring line 51.

In the state where the projection 2a of the wireless power receiving device 2 and the recess 1a of the wireless power sending device 1 are fitted to each other as illustrated in FIG. 4(b), the power receiving device-side active electrode 41A and the power sending device-side active electrode 31A are positioned in opposing relation. At that time, a predetermined coupling capacitance is generated between the power receiving device-side active electrode 41A and the power sending device-side active electrode 31A.

Furthermore, the power receiving device-side passive electrode 41P and the power sending device-side passive electrode 31P are positioned close to each other. At that time, a coupling capacitance is generated between the power receiving device-side passive electrode 41P and the power sending device-side passive electrode 31P.

Moreover, in the fitted state, the power sending device-side active electrode 31A is pushed down against the biasing force of the spring 32 and is brought into contact with the active wiring line 51. At that time, the voltage of the active wiring line 51 is applied to the power sending device-side active electrode 31A. As a result, electric power is wirelessly transferred between the wireless power receiving device 2 and the wireless power sending device 1 through the coupling capacitance.

According to this embodiment, the active potential is applied not to all the power sending device-side active electrodes 31A, but to only the power sending device-side active electrodes 31A in an area where the wireless power receiving device 2 is placed. Accordingly, electric fields are not radiated from the power sending device-side active electrodes 31A positioned other than the area where the wireless power receiving device 2 is placed. Hence unwanted radiation of electric fields is suppressed. In addition, since electric power is not supplied to the power sending device-side active electrodes 31A that are not in use, the transfer efficiency of electric power is increased.

### 3. Recapitulation

As described above, the wireless power sending device 1 according to this embodiment transfers electric power to the wireless power receiving device 2 with the electric-field coupling scheme.

The wireless power sending device 1 includes: the casing 1A that has the placing surface 1B allowing the wireless power receiving device 2 to be placed thereon, and that has the plural recesses 1a arranged in the placing surface 1B in a distributed fashion; the plural active electrodes 31A (movable electrodes) that are accommodated in the plural recesses 1a, and that are movable between the first position and the second position in the direction substantially perpendicular to the placing surface 1B; the passive electrodes 31P (fixed electrodes) arranged in the recesses 1a of the casing 1A and/or surrounding portions thereof; and the step-up unit 21 (power supply unit) that outputs a first potential and a second potential having a larger absolute value than the first potential, wherein the passive potential (first potential) is applied to the passive electrodes 31P (fixed electrodes), and the active potential (second potential) is applied to the active electrodes 31A (movable electrodes) when the active electrodes 31A (movable electrodes) are at the second position.

With features described above, in the wireless power sending device 1 of electric-field coupling type, an increase in the transfer efficiency of electric power and suppression of the unwanted radiation of electric fields can be realized while the allowable range of placement of the wireless power receiving device 2 is widened.

The wireless power sending device 1 according this embodiment further includes the spring 32 (biasing means) that biases the active electrode 31A (movable electrode) to be located at the first position when the wireless power receiving device 2 is not placed on the placing surface 1B.

With the feature described above, when the wireless power receiving device 2 is not placed on the placing surface 1B, the active potential is not applied to the active electrodes 31A. Therefore, the unwanted radiation of electric fields can be suppressed satisfactorily.

The wireless power receiving device 2 according to this embodiment receives electric power transferred from the wireless power sending device 1 with the electric-field coupling scheme.

The wireless power receiving device 2 includes: the casing 2A; and the active electrodes 41A (first electrodes) and the passive electrodes 41P (second electrodes), which receive the electric power transferred from the wireless power sending device 1, wherein the plural projections 2a are arranged on the principal surface 2B of the casing 2A in a distributed fashion, the active electrodes 41A (first electrodes) are arranged in top portions (predetermined portions) of the projections 2a, and the passive electrodes 41P (second electrodes) are arranged in the principal surface 2B at places other than the top portions of the projection 2a (other than the predetermined portions of the projections).

The wireless power transfer system according to this embodiment includes the wireless power sending device 1 and the wireless power receiving device 2. In this case, the plural recesses 1a of the wireless power sending device 1 arranged in predetermined positional relation, and the plural projections 2a of the wireless power receiving device 2 are arranged in the predetermined positional relation.

The projections 2a of the wireless power receiving device 2 and the recesses 1a of the wireless power sending device 1 are formed in shapes capable of being fitted to each other, and upon fitting of the projections and the recesses, the active electrodes 31A (movable electrodes) of the wireless power sending device 1 are displaced to the second position by the projections 2a of the wireless power receiving device 2; the predetermined positional relation is set as positional relation allowing the plural projections 2a of the wireless power receiving device 2 to be fitted to the plural recesses 1a of the wireless power sending device 1; and when the projections 2a of the wireless power receiving device 2 are fitted to the recesses 1a of the wireless power sending device 1, the second potential is applied to ones of the plural active electrodes 31A (movable electrodes) of the wireless power sending device 1, which ones are displaced to the second position.

With the features described above, when the wireless power receiving device 2 is not placed on the placing surface 1B, the active potential is not applied to the active electrodes 31A. Therefore, the unwanted radiation of electric fields can be suppressed satisfactorily.

Thus, in the wireless power transfer system, an increase in the transfer efficiency of electric power and suppression of the unwanted radiation of electric fields can be realized while the allowable range of placement of the wireless power receiving device 2 is widened.

While, in this embodiment, the power receiving device-side active electrode 41A and the power receiving device-side passive electrode 41P are disposed in all the projections 2a of the wireless power receiving device 2, those electrodes may not be disposed in all the projections 2a. For example, those electrodes may be arranged in every other one of the projections 2a. Such an arrangement enables the coupling capacitance to be adjusted. In other words, the coupling capacitance can be adjusted without changing the resonant frequency and the coupling coefficient.

### Second Embodiment

Variations of the first embodiment are described in second to eighth embodiments. More specifically, in the second to fifth embodiments, the structures of the power receiving device-side electrode portions of the wireless power receiving device and the power sending device-side electrode portions of the wireless power sending device are different from those in the first embodiment. The other structures are the same. Because individual component structures of the second to eighth embodiments are the same as or similar to those in the first embodiment except for the above-mentioned point, the same reference symbols as those in the first embodiment are used except for the wireless power receiving device and the wireless power sending device.

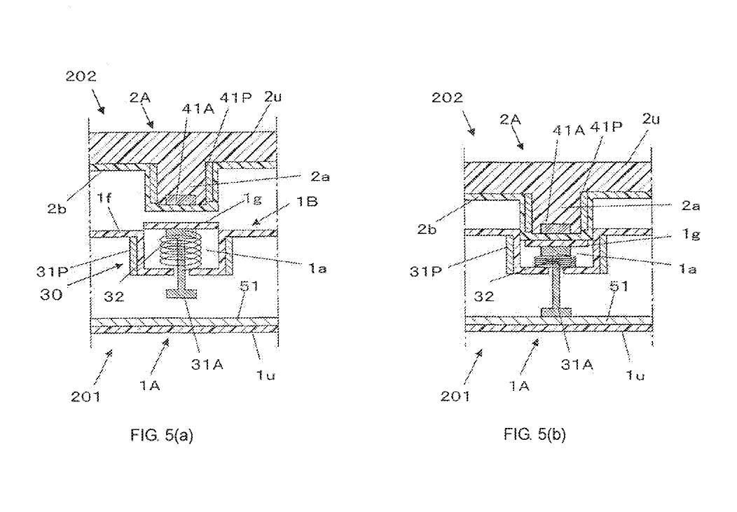

A wireless power sending and receiving system according to the second embodiment is first described. FIGS. 5(a) and 5(b) are sectional views illustrating respective structures of a power receiving device-side electrode portion of a wireless power receiving device and a power sending device-side electrode portion of a wireless power sending device according to the second embodiment. More specifically, FIG. 5(a) represents a state where a projection of the wireless power receiving device and a recess of the wireless power sending device are not fitted to each other, and FIG. 5(b) represents a state where the projection of the wireless power receiving device and the recess of the wireless power sending device are fitted to each other.

As illustrated in FIG. 5(a), in the wireless power receiving device 202 according to this embodiment, the power receiving device-side active electrode 41A is arranged at a lower surface (top surface) of the cylindrical projection 2a, and the power receiving device-side passive electrode is arranged at a lateral surface of the cylindrical projection 2a.

In the wireless power sending device 201 according to this embodiment, the power sending device-side active electrode 31A is constituted as a movable electrode, and the power sending device-side passive electrode 31P is arranged at a lateral surface of the recess 1a.

In the state where the projection 2a of the wireless power receiving device 202 and the recess 1a of the wireless power sending device 201 are fitted to each other as illustrated in FIG. 5(b), the power receiving device-side active electrode 41A and the power sending device-side active electrode 31A are positioned in opposing relation. At that time, a coupling capacitance is generated between the power receiving device-side active electrode 41A and the power sending device-side active electrode 31A.

Furthermore, the power receiving device-side passive electrode 41P and the power sending device-side passive electrode 31P are positioned close to each other. At that time, a coupling capacitance is generated between the power receiving device-side passive electrode 41P and the power sending device-side passive electrode 31P.

Moreover, the power sending device-side active electrode 31A is pushed down against the biasing force of the spring 32 and is brought into contact with the active wiring line 51. At that time, the voltage of the active wiring line 51 is applied to the power sending device-side active electrode 31A. As a result, electric power is wirelessly transferred between the wireless power receiving device 202 and the wireless power sending device 201 through the coupling capacitance.

In particular, according to this embodiment, the following advantageous effect is obtained in addition to those of the first embodiment. Since the power sending device-side passive electrode 31P is disposed at the lateral surface of the recess 1a, the placing surface 1B of the wireless power sending device 201 can be utilized for another use.

### Third Embodiment

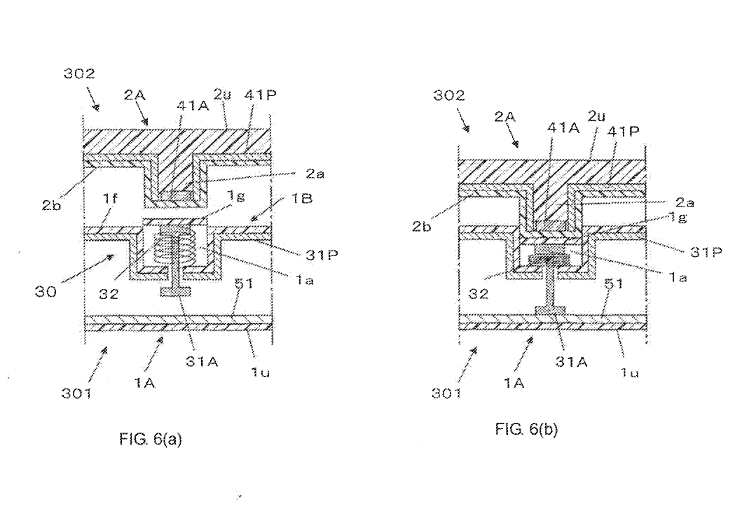

A wireless power sending and receiving system according to the third embodiment is described below. FIGS. 6(a) and 6(b) are sectional views illustrating respective structures of a power receiving device-side electrode portion of a wireless power receiving device and a power sending device-side electrode portion of a wireless power sending device according to the third embodiment. More specifically, FIG. 6(a) represents a state where a projection of the wireless power receiving device and a recess of the wireless power sending device are not fitted to each other, and FIG. 6(b) represents a state where the projection of the wireless power receiving device and the recess of the wireless power sending device are fitted to each other.

As illustrated in FIG. 6(a), in the wireless power receiving device 302 according to this embodiment, the power receiving device-side active electrode 41A is arranged at the lower surface of the projection 2a having the cylindrical shape, and the power receiving device-side passive electrode 41P is arranged over the lateral surface of the cylindrical projection 2a and the lower surface of the lower side portion 2u of the casing 2A.

In the wireless power sending device 301 according to this embodiment, the power sending device-side active electrode 31A is constituted as a movable electrode, and the power sending device-side passive electrode 31P is arranged over a lateral surface and a lower surface of the recess 1a having the cylindrical shape and over a lower surface of the upper side portion 1f of the casing 1A.

In the state where the projection 2a of the wireless power receiving device 302 and the recess 1a of the wireless power sending device 301 are fitted to each other as illustrated in FIG. 6(b), the power receiving device-side active electrode 41A and the power sending device-side active electrode 31A are positioned in opposing relation. At that time, a coupling capacitance is generated between the power receiving device-side active electrode 41A and the power sending device-side active electrode 31A.

Furthermore, the power receiving device-side passive electrode 41P and the power sending device-side passive electrode 31P are positioned close to each other. At that time, a coupling capacitance is generated between the power receiving device-side passive electrode 41P and the power sending device-side passive electrode 31P.

Moreover, the power sending device-side active electrode 31A is pushed down against the biasing force of the spring 32 and is brought into contact with the active wiring line 51. At that time, the voltage of the active wiring line 51 is applied to the power sending device-side active electrode 31A. As a result, electric power is wirelessly transferred between the wireless power receiving device 302 and the wireless power sending device 301 through the coupling capacitance.

In particular, according to this embodiment, since the power sending device-side passive electrode 31P is disposed over a larger region where the power sending device-side active electrode 31A is not disposed, a shielding property of the wireless power sending device 301 can be improved. Hence the unwanted radiation of electric fields from the active wiring line 51 and the power sending device-side active electrode 31A can be suppressed more effectively. Furthermore, the electric-field coupling between the power receiving device-side passive electrode 41P and the power sending device-side passive electrode 31P can be intensified.

### Fourth Embodiment

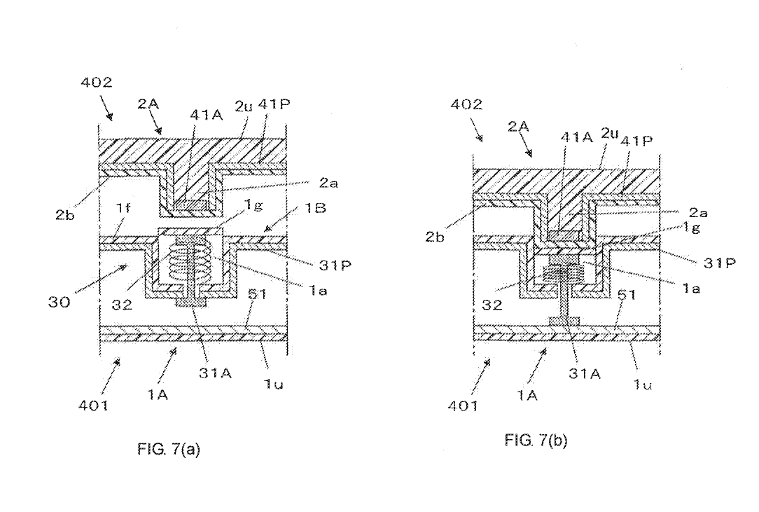

A wireless power sending and receiving system according to the fourth embodiment is described below. FIGS. 7(a) and 7(b) are sectional views illustrating respective structures of a power receiving device-side electrode portion of a wireless power receiving device and a power sending device-side electrode portion of a wireless power sending device according to the fourth embodiment. More specifically, FIG. 7(a) represents a state where a projection of the wireless power receiving device and a recess of the wireless power sending device are not fitted to each other, and FIG. 7(b) represents a state where the projection of the wireless power receiving device and the recess of the wireless power sending device are fitted to each other.

As illustrated in FIG. 7(a), in the wireless power receiving device 402 according to this embodiment, the power receiving device-side active electrode 41A is arranged at the lower surface of the projection 2a having the cylindrical shape, and the power receiving device-side passive electrode 41P is arranged over the lateral surface of the cylindrical projection 2a and the lower surface of the lower side portion 2u of the casing 2A.

In the wireless power sending device 401 according to this embodiment, the power sending device-side active electrode 31A is constituted as a movable electrode, and the power sending device-side passive electrode 31P is arranged over the lateral surface and the lower surface of the recess 1a having the cylindrical shape and over the lower surface of the upper side portion 1f of the casing 1A. In the state where the projection 2a of the wireless power receiving device 402 and the recess 1a of the wireless power sending device 401 are not fitted to each other, the power sending device-side active electrode 31A is pressed against the power sending device-side passive electrode 31P by the biasing force of the spring 32. In the not-fitted state, therefore, the power sending device-side active electrode 31A functions substantially as the power sending device-side passive electrode.

In the state where the projection 2a of the wireless power receiving device 402 and the recess 1a of the wireless power sending device 401 are fitted to each other as illustrated in FIG. 7(b), the power receiving device-side active electrode 41A and the power sending device-side active electrode 31A are positioned in opposing relation. At that time, a coupling capacitance is generated between the power receiving device-side active electrode 41A and the power sending device-side active electrode 31A.

Furthermore, the power receiving device-side passive electrode 41P and the power sending device-side passive electrode 31P are positioned close to each other. At that time, a coupling capacitance is generated between the power receiving device-side passive electrode 41P and the power sending device-side passive electrode 31P.

Moreover, the power sending device-side active electrode 31A is pushed down against the biasing force of the spring 32 and is brought into contact with the active wiring line 51. At that time, the voltage of the active wiring line 51 is applied to the power sending device-side active electrode 31A. As a result, electric power is wirelessly transferred between the wireless power receiving device 402 and the wireless power sending device 401 through the coupling capacitance.

In particular, according to this embodiment, since the power sending device-side active electrode 31A functions substantially as the power sending device-side passive electrode in the state where the projection 2a of the wireless power receiving device 402 and the recess 1a of the wireless power sending device 401 are not fitted to each other, the shielding property of the wireless power sending device 401 can be further improved. Accordingly, the unwanted radiation of electric fields from the active wiring line 51 and the power sending device-side active electrode 31A can be suppressed more effectively.

### Fifth Embodiment

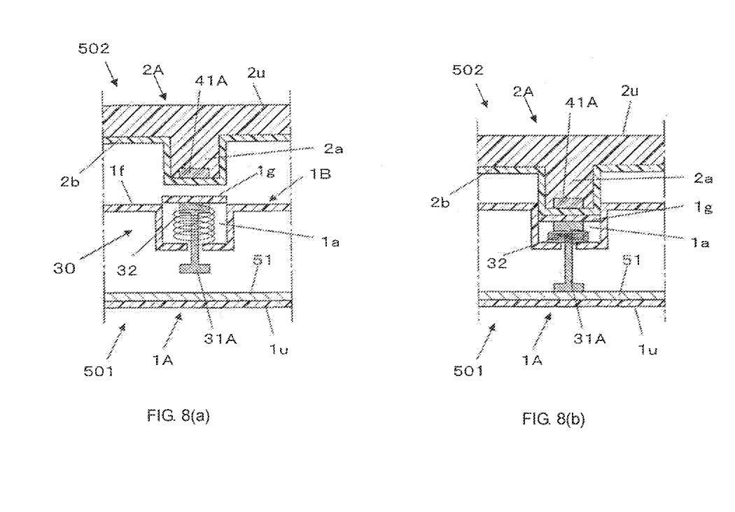

FIGS. 8(a) and 8(b) are sectional views illustrating respective structures of a power receiving device-side electrode portion of a wireless power receiving device and a power sending device-side electrode portion of a wireless power sending device according to the fifth embodiment. More specifically, FIG. 8(a) represents a state where a projection of the wireless power receiving device and a recess of the wireless power sending device are not fitted to each other, and FIG. 8(b) represents a state where the projection of the wireless power receiving device and the recess of the wireless power sending device are fitted to each other.

As illustrated in FIG. 8(a), in the wireless power receiving device 502 according to this embodiment, the power receiving device-side active electrode 41A is arranged at the top surface of the projection 2a. The power receiving device-side passive electrode is provided by a ground member that is disposed in the wireless power receiving device 502.

In the wireless power sending device 501 according to this embodiment, the power sending device-side active electrode 31A is constituted as a movable electrode. The power sending device-side passive electrode is provided by a ground member that is disposed in the wireless power sending device 501.

In the state where the projection 2a of the wireless power receiving device 502 and the recess 1a of the wireless power sending device 501 are fitted to each other as illustrated in FIG. 8(b), the power receiving device-side active electrode 41A and the power sending device-side active electrode 31A are positioned in opposing relation. At that time, a predetermined coupling capacitance is generated between the power receiving device-side active electrode 41A and the power sending device-side active electrode 31A. A coupling capacitance is also generated between the power receiving device-side passive electrode (ground member) and the power sending device-side passive electrode (ground member).

Moreover, the power sending device-side active electrode 31A is pushed down against the biasing force of the spring 32 and is brought into contact with the active wiring line 51. At that time, the voltage of the active wiring line 51 is applied to the power sending device-side active electrode 31A. As a result, electric power is wirelessly transferred between the wireless power receiving device 502 and the wireless power sending device 501 through the coupling capacitance.

In particular, according to this embodiment, the following advantageous effect is obtained in addition to those of the first embodiment. Since the power receiving device-side passive electrode and the power sending device-side passive electrode are provided by the ground members that are inherently disposed in the respective devices, the structures of the wireless power receiving device 502 and the wireless power sending device 501 can be simplified.

### Sixth Embodiment

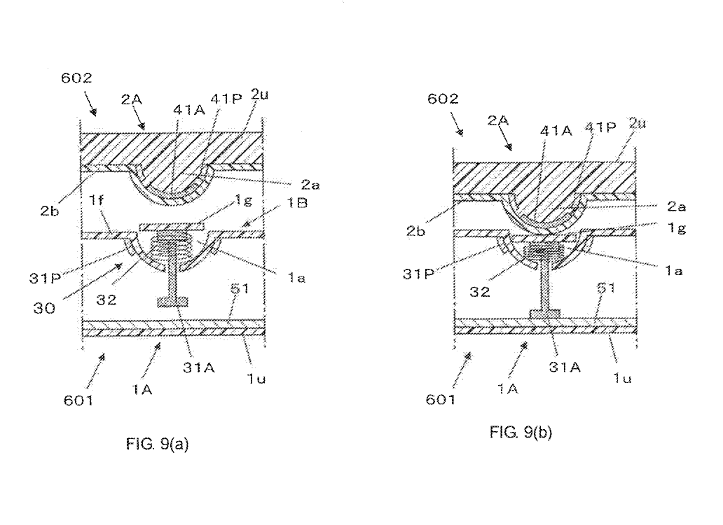

A wireless power sending and receiving system according to the sixth embodiment is described below. FIGS. 9(a) and 9(b) are sectional views illustrating respective structures of a power receiving device-side electrode portion of a wireless power receiving device and a power sending device-side electrode portion of a wireless power sending device according to the sixth embodiment. More specifically, FIG. 9(a) represents a state where a projection of the wireless power receiving device and a recess of the wireless power sending device are not fitted to each other, and FIG. 9(b) represents a state where the projection of the wireless power receiving device and the recess of the wireless power sending device are fitted to each other.

As illustrated in FIG. 9(a), in the sixth embodiment, the projection 2a formed on the casing 2A of the wireless power receiving device 602 has a semispherical shape, and the recess 1a formed in the upper side portion 1f of the casing 1A of the wireless power sending device 601 has a semispherical shape capable of being fitted with the projection 2a in the casing 2A of the wireless power receiving device 602.

In the wireless power receiving device 602, the power receiving device-side active electrode 41A is arranged at a top surface of the projection 2a having the semispherical shape, and the power receiving device-side passive electrode 41P is arranged at a lateral surface (i.e., a surface except for the top surface) of the semispherical projection 2a.

In the wireless power sending device 601, the power sending device-side active electrode 31A is constituted as a movable electrode, and the power sending device-side passive electrode 31P is arranged at a lateral surface (except for a top surface (surface including the most protruded portion)) of the recess 1a.

In the state where the projection 2a of the wireless power receiving device 602 and the recess 1a of the wireless power sending device 601 are fitted to each other as illustrated in FIG. 9(b), the power receiving device-side active electrode 41A and the power sending device-side active electrode 31A are positioned in opposing relation. At that time, a coupling capacitance is generated between the power receiving device-side active electrode 41A and the power sending device-side active electrode 31A.

Furthermore, the power receiving device-side passive electrode 41P and the power sending device-side passive electrode 31P are positioned close to each other. At that time, a coupling capacitance is generated between the power receiving device-side passive electrode 41P and the power sending device-side passive electrode 31P.

Moreover, the power sending device-side active electrode 31A is pushed down against the biasing force of the spring 32 and is brought into contact with the active wiring line 51. At that time, the voltage of the active wiring line 51 is applied to the power sending device-side active electrode 31A. As a result, electric power is wirelessly transferred between the wireless power receiving device 602 and the wireless power sending device 601 through the coupling capacitance.

This embodiment represents, particularly, the case where the recess and the projection have the shape other than the cylindrical shape. The semispherical recess and projection have the feature that they are easier to work than the cylindrical recess and projection. While FIGS. 9(a) and 9(b) are illustrates an example in which the insulator 1g and the upper portion of the power sending device-side active electrode 31A have a flat surface shape, they may be formed to have surfaces curved along the semispherical surface on the power receiving side in order to further increase a coupling capacitance value between the active electrodes on the receiving and sending sides.

### Seventh Embodiment

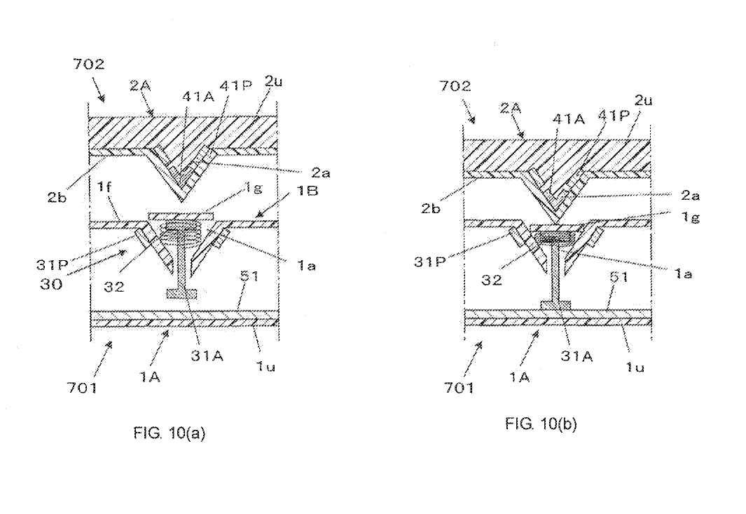

A wireless power sending and receiving system according to the seventh embodiment is described below. FIGS. 10(a) and 10(b) are sectional views illustrating respective structures of a power receiving device-side electrode portion of a wireless power receiving device and a power sending device-side electrode portion of a wireless power sending device according to the seventh embodiment. More specifically, FIG. 10(a) represents a state where a projection of the wireless power receiving device and a recess of the wireless power sending device are not fitted to each other, and FIG. 10(b) represents a state where the projection of the wireless power receiving device and the recess of the wireless power sending device are fitted to each other.

As illustrated in FIG. 10(a), in the seventh embodiment, the projection 2a formed on the casing 2A of the wireless power receiving device 702 has a conical shape, and the recess 1a formed in the upper side portion 1f of the casing 1A of the wireless power sending device 701 has a conical shape capable of being fitted with the projection 2a on the casing 2A of the wireless power receiving device 702.

In the wireless power receiving device 702, the power receiving device-side active electrode 41A is arranged at a top portion (i.e., a portion including the most protruded tip) of the projection 2a having the conical shape, and the power receiving device-side passive electrode 41P is arranged at a lateral surface (i.e., a surface except for a top surface) of the conical projection 2a.

In the wireless power sending device 701, the power sending device-side active electrode 31A is constituted as a movable electrode, and the power sending device-side passive electrode 31P is arranged at a lateral surface (i.e., a surface except for a top portion) of the conical portion.

In the state where the projection 2a of the wireless power receiving device 702 and the recess 1a of the wireless power sending device 701 are fitted to each other as illustrated in FIG. 10(b), the power receiving device-side active electrode 41A and the power sending device-side active electrode 31A are positioned in opposing relation. At that time, a coupling capacitance is generated between the power receiving device-side active electrode 41A and the power sending device-side active electrode 31A.

Furthermore, the power receiving device-side passive electrode 41P and the power sending device-side passive electrode 31P are positioned close to each other. At that time, a coupling capacitance is generated between the power receiving device-side passive electrode 41P and the power sending device-side passive electrode 31P.

Moreover, the power sending device-side active electrode 31A is pushed down against the biasing force of the spring 32 and is brought into contact with the active wiring line 51. At that time, the voltage of the active wiring line 51 is applied to the power sending device-side active electrode 31A. As a result, electric power is wirelessly transferred between the wireless power receiving device 702 and the wireless power sending device 701 through the coupling capacitance.

This embodiment represents, particularly, the case where the recess and the projection have the shape other than the cylindrical shape. The conical recess and projection have the feature that they are easier to work than the cylindrical recess and projection.

### Eighth Embodiment

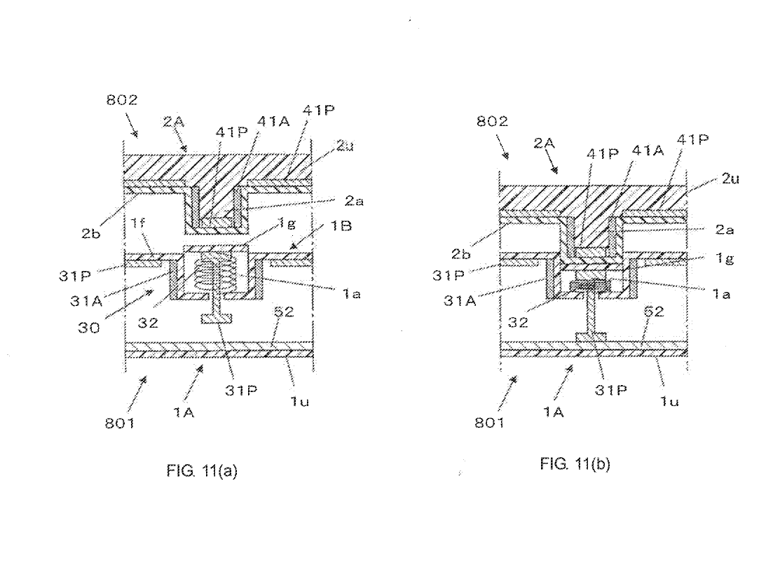

A wireless power sending and receiving system according to the eighth embodiment is described below. FIGS. 11(a) and 11(b) are sectional views illustrating respective structures of a power receiving device-side electrode portion of a wireless power receiving device and a power sending device-side electrode portion of a wireless power sending device according to the eighth embodiment. More specifically, FIG. 11(a) represents a state where a projection of the wireless power receiving device and a recess of the wireless power sending device are not fitted to each other, and FIG. 11(b) represents a state where the projection of the wireless power receiving device and the recess of the wireless power sending device are fitted to each other.

As illustrated in FIG. 11(a), in the wireless power receiving device 802 according to the eighth embodiment, the power receiving device-side active electrode 41A is arranged at the lateral surface of the projection 2a having the cylindrical shape. The power receiving device-side passive electrode 41P is arranged at each of the lower surface of the cylindrical projection 2a and the lower surface of the lower side portion 2u of the casing 2A.

In the wireless power sending device 801, the power sending device-side passive electrode 31P is constituted as a movable electrode. The power sending device-side active electrode 31A is arranged at the lateral surface of the recess 1a having the cylindrical shape. The power sending device-side passive electrode 31P is further arranged at the lower surface of the upper side portion 1f of the casing 1A.

In the state where the projection 2a of the wireless power receiving device 802 and the recess 1a of the wireless power sending device 801 are fitted to each other as illustrated in FIG. 11(b), the power receiving device-side passive electrode 41P and the power sending device-side passive electrode 31P are positioned in opposing relation. At that time, a coupling capacitance is generated between the power receiving device-side passive electrode 41P and the power sending device-side passive electrode 31P.

Furthermore, the power receiving device-side active electrode 41A and the power sending device-side active electrode 31A are positioned close to each other. At that time, a coupling capacitance is generated between the power receiving device-side active electrode 41A and the power sending device-side active electrode 31A.

Moreover, the power sending device-side passive electrode 31P is pushed down against the biasing force of the spring 32 and is brought into contact with the passive wiring line 52. At that time, the passive potential is applied to the power sending device-side passive electrode 31P. As a result, electric power is wirelessly transferred between the wireless power receiving device 802 and the wireless power sending device 801 through the coupling capacitance.

In this embodiment, the active potential is always applied to the power sending device-side active electrode 31A. However, the power sending device-side passive electrode 31P is arranged at the lower surface of the upper side portion 1f of the casing 1A. Therefore, the power sending device-side passive electrode 31P functions as a shielding member. Accordingly, the unwanted radiation of electric fields from the active wiring line and the power sending device-side active electrode 31A can be suppressed.

Moreover, since there are no mechanical contacts in a high-voltage section, reliability and safety in contact portions are improved.

### Ninth Embodiment

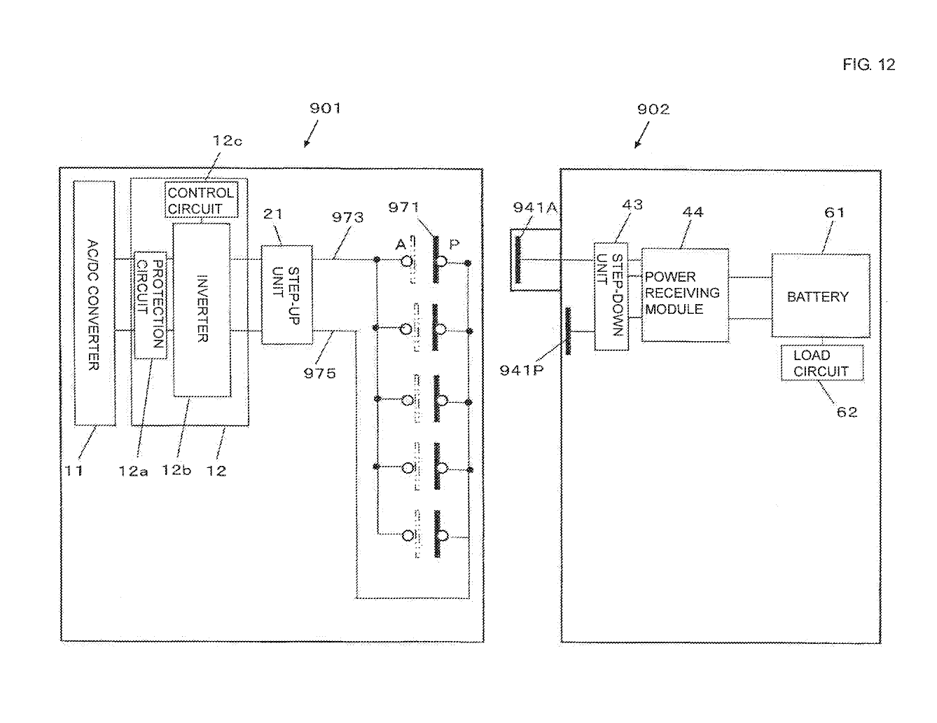

A wireless power sending and receiving system according to a ninth embodiment is described below. FIG. 12 is a block diagram illustrating a configuration of the wireless power sending and receiving system according to the ninth embodiment. In this embodiment, structures of a passive electrode 941P and an active electrode 941A of a wireless power receiving device 902, electrode structures of a wireless power sending device 901, etc. are different from those in the first to eighth embodiments. In the wireless power sending device 901 according to this embodiment, particularly, a passive electrode and an active electrode are constituted by a movable electrode 971. Moreover, an active wiring line 973 for applying the active potential to the movable electrode 971 and a passive wiring line 975 for applying the passive potential to the movable electrode 971 extend from the step-up unit 21.

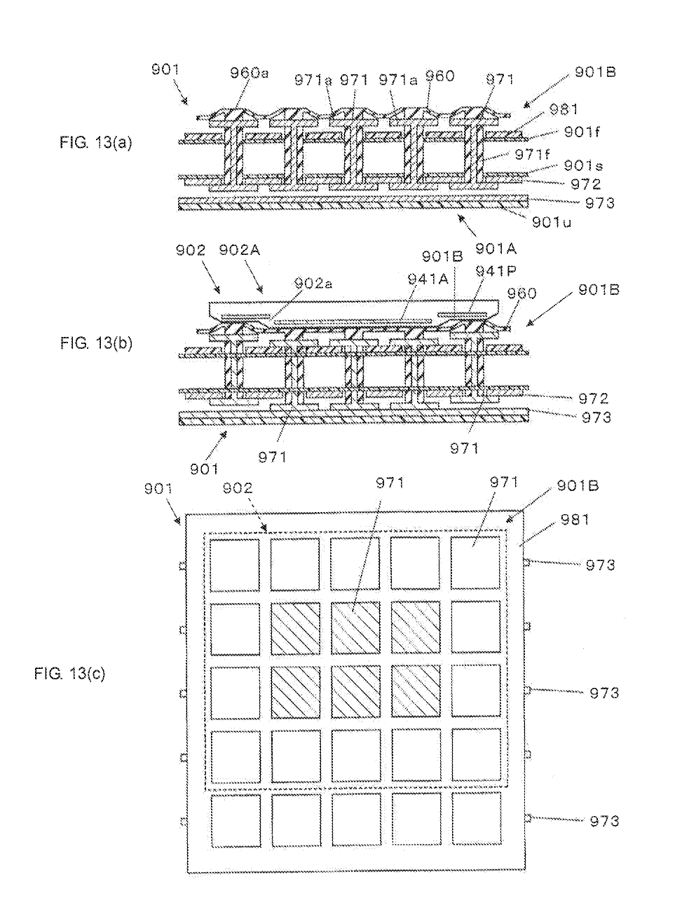

FIGS. 13(a) and 13(b) are sectional views and FIG. 13(c) is a plan view illustrating respective structures of a power receiving device-side electrode portion of the wireless power receiving device and a power sending device-side electrode portion of the wireless power sending device according to the ninth embodiment. More specifically, FIG. 13(a) represents a state of the power sending device where a projection of the wireless power receiving device and a recess of the wireless power sending device are not fitted to each other, and FIGS. 13(b) and 13(c) represent a state where the projection of the wireless power receiving device and the recess of the wireless power sending device are fitted to each other.

In this embodiment, a casing 901A of the wireless power sending device 901 includes an upper side portion 901f, a lower side portion 901u, and a support portion 901s disposed between the upper and lower side portions. The upper side portion 901f of the casing 901A has the function of providing a placing surface 901B on which the wireless power receiving device 902 can be placed.

An insulator 981 is arranged on an upper surface of the upper side portion 901f.

Plural holes are formed at equal intervals in each of the upper side portion 901f, the lower side portion 901u, the support portion 901s, and the insulator 981. The movable electrode 971 is inserted through each of the holes to be movable relative to the upper side portion 901f, i.e., in a direction perpendicular to the placing surface 901B. The movable electrode 971 is movable between a first position (i.e., a position at which a lower end portion of the movable electrode 971 is contacted with a later-described floating electrode 972) and a second position (i.e., a position at which the lower end portion of the movable electrode 971 is contacted with the active wiring line 973 described later).

The floating electrode 972 is disposed at a lower surface of the support portion 901s between adjacent two of the holes. The floating electrode 972 is connected to the passive wiring line 975. Thus, the floating electrode 972 functions as a passive electrode.

The active wiring line 973 is disposed at an upper surface of the lower side portion 901u of the casing 901A of the wireless power sending device 901. The active wiring line 973 is not covered with a coating or the like, and its metal surface is exposed. An active voltage (A) stepped up by the step-up unit 21 is applied to the active wiring line 973.

On the plural movable electrodes 971, elastic member 960 is disposed to cover respective upper end portions of the movable electrodes 971. The elastic member 960 is made of an insulator, such as rubber. The elastic member 960 includes a protruding portion 960a that is formed at a position above each movable electrode 971 in the shape protruding upwards. The protruding portion 960a is usually in a state protruding upwards (hereinafter referred to also as a “protruding state”), as illustrated in FIG. 13(a). However, when the protruding portion 960a is pressed from above as illustrated in FIG. 13(b), the protruding portion 960a is deformed into a flat shape (hereinafter referred to also as a “flat state”). Upon release from the pressing, the protruding portion 960a is returned to the state illustrated in FIG. 13(a) due to its own elasticity.

Each movable electrode 971 has an I-like shape. An intermediate portion of the movable electrode 971 is covered with an insulator 971f. The movable electrode 971 is fixed to a lower surface of the protruding portion 960a of the elastic member 960. Therefore, the movable electrode 971 is movable up and down corresponding to the above-described deformation of the elastic member 960. When the protruding portion 960a of the elastic member 960 is in the protruding state, the lower end portion of the movable electrode 971 is contacted with the floating electrode 972. In that state, the movable electrode 971 functions as a passive electrode. On the other hand, when the protruding portion 960a of the elastic member 960 is in the flat state, the lower end portion of the movable electrode 971 is contacted with the active wiring line 973. In that state, the movable electrode 971 functions as an active electrode.

In this embodiment, a projection projecting in a trapezoidal shape is formed over a predetermined surface of the casing of the wireless power receiving device 902. The power receiving device-side active electrode is arranged at a bottom surface of the projection, and the power receiving device-side passive electrode is arranged in a portion surrounding the projection.

FIGS. 13(b) and 13(c) illustrate one example of the state where the wireless power receiving device 902 is placed on the wireless power sending device 901. In the illustrated example, the protruding portions 960a of the wireless power sending device 901, which are positioned in second and third rows counting from above and in second to fourth columns counting from left in FIG. 13(c), are in the flat state because the wireless power receiving device 902 is placed over those protruding portions 960a. At that time, the lower end portions of the movable electrodes 971 corresponding to the protruding portions 960a, which are in the flat state, are contacted with the active wiring line 973, whereby those movable electrodes 971 function as active electrodes. Furthermore, those power sending device-side active electrodes are positioned in opposing relation to the power receiving device-side active electrodes 941A of the wireless power receiving device 902. On the other hand, the movable electrodes 971 corresponding to the protruding portions 960a, which are not in the flat state, are contacted with the floating electrodes 972, whereby those movable electrodes 971 function as the power sending device-side passive electrodes. Those power sending device-side passive electrodes are positioned in opposing relation to the power receiving device-side passive electrodes 941P of the wireless power receiving device 902. As a result, electric power can be transferred from the wireless power sending device 901 to the wireless power receiving device 902 through the electric-field coupling.

In this embodiment, when the wireless power receiving device 902 is placed on the wireless power sending device 901, a peak of the sent voltage is detected at a predetermined frequency and the power sending is started in the wireless power sending device 901.

As described above, the wireless power sending device 901 according to this embodiment transfers electric power to the wireless power receiving device 902 with the electric-field coupling scheme.

The wireless power sending device 901 includes: the casing 901A that has the placing surface 901B allowing the wireless power receiving device 902 to be placed thereon; the plural movable electrodes 971 that are arranged in the placing surface 901B of the casing in a distributed fashion, and that are movable between a first position and a second position in a direction substantially perpendicular to the placing surface 901B; and the step-up unit 21 (power supply unit) that outputs a first potential and a second potential having a larger absolute value than the first potential, wherein the passive potential (first potential) is applied to the movable electrode 971 when the movable electrode is at the first position, and the active potential (second potential) is applied to the movable electrode 971 when the movable electrode 971 is at the second position.

With features described above, in the wireless power sending device 901 of electric-field coupling type, an increase in the transfer efficiency of electric power and suppression of the unwanted radiation of electric fields can be realized while the allowable range of placement of the wireless power receiving device 902 is widened.

In the wireless power sending device 901 according to this embodiment, the step-up unit 21 (power supply unit) outputs a ground potential as the first potential, and a predetermined potential, which is higher than the ground potential, as the second potential.

The wireless power sending device 901 according this embodiment further includes the elastic member 960 (biasing means) that biases the movable electrode 971 to be located at the first position when the wireless power receiving device 902 is not placed on the placing surface 901B.

With the feature described above, when the wireless power receiving device 902 is not placed on the placing surface 901B, the active potential is not applied to the movable electrodes 971. Therefore, the unwanted radiation of electric fields can be suppressed satisfactorily.

The wireless power receiving device 902 according to this embodiment receives electric power transferred from the wireless power sending device 901 with the electric-field coupling scheme.

The wireless power receiving device 902 includes: the casing 902A; and the active electrode 941A (first electrode) and the passive electrode 941P (second electrode), which receive the electric power transferred from the wireless power sending device 901, wherein the projection 901a is disposed on the principal surface 901B of the casing 901A, the active electrode 941A (first electrode) is arranged in the projection 902a, and the passive electrode 941P (second electrode) is arranged in a portion of the casing 902A other than the projection 902a.

The wireless power transfer system according to this embodiment includes the wireless power sending device 901 and the wireless power receiving device 902.

When the wireless power receiving device 902 is placed on the placing surface 901B of the wireless power sending device 901, ones of the plural movable electrodes 971 of the wireless power sending device 901, those ones being positioned in a region of the placing surface opposing to the projection 902a of the wireless power receiving device 902, are displaced to the second position.

With features described above, in the wireless power transfer system of electric-field coupling type, an increase in the transfer efficiency of electric power and suppression of the unwanted radiation of electric fields can be realized while the allowable range of placement of the wireless power receiving device 902 is widened.

### Tenth Embodiment

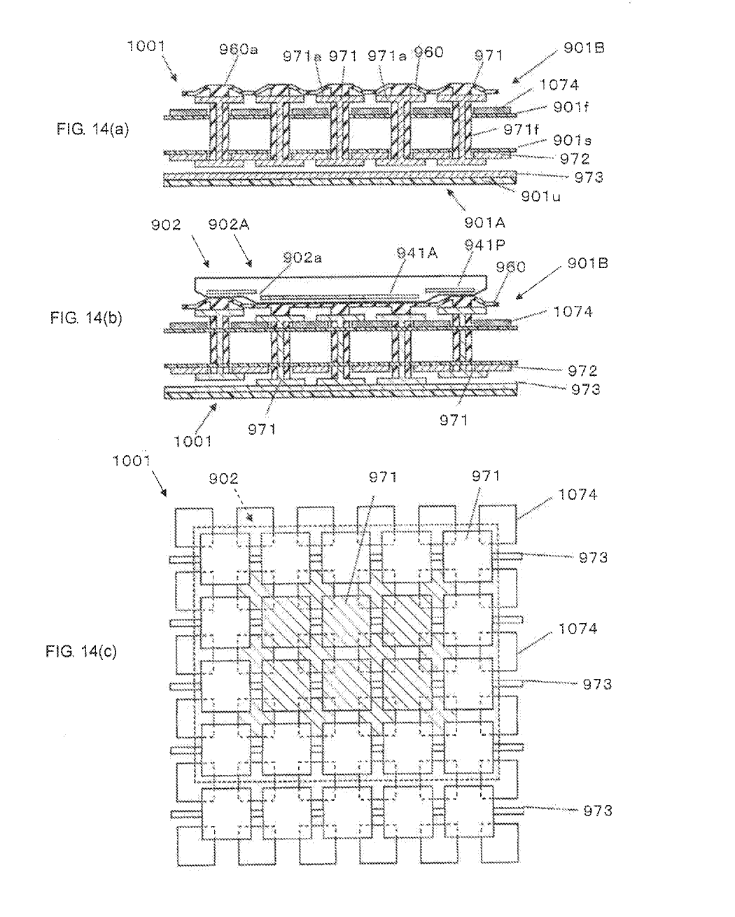

A wireless power sending and receiving system according to a tenth embodiment is described below. FIGS. 14(a) and 14(b) are sectional views illustrating respective structures of a power receiving device-side electrode portion of a wireless power receiving device and a power sending device-side electrode portion of a wireless power sending device according to the tenth embodiment. More specifically, FIG. 14(a) represents a state where a projection of the wireless power receiving device and a recess of the wireless power sending device are not fitted to each other, and FIG. 14(b) represents a state where the projection of the wireless power receiving device and the recess of the wireless power sending device are fitted to each other.

In this embodiment, floating electrodes 1074 are arranged instead of the insulator 981 in the wireless power sending device 901 according to the ninth embodiment. The floating electrodes 1074 are disposed at equal intervals between the holes in the upper side portion 901f. The floating electrodes 1074 are each disposed in overlapping relation to the upper end portion 971a of the movable electrode 971 that is positioned adjacent to the relevant floating electrode when viewed in the moving direction of the movable electrode 971. The other structure of the wireless power sending device 901 is the same as that in the ninth embodiment. Furthermore, the wireless power receiving device 902 is the same as that in the ninth embodiment.

With this embodiment, when the protruding portions 960a of the elastic member 960 are pressed into the flat state and the upper end portions 971a of the movable electrodes 971 are contacted with the floating electrodes 1074, potentials of the floating electrodes 1074 become equal to the potential of the movable electrodes 971 because of contact between the floating electrodes 1074 and the upper end portions 971a of the movable electrodes 971. In other words, as illustrated in FIG. 14(c), a total area of portions functioning as the active electrodes per unit area is increased (as represented by a hatched portion in FIG. 14(c)). Accordingly, electric power energy transferred per unit area is increased.

As described above, in this embodiment, the floating electrodes (conductors) 1074 are arranged between the regions of the placing surface 901B where the movable electrodes 971 are arranged, and the movable electrodes 971 are contacted with the floating electrodes (conductors) 1074 when the movable electrodes 971 are at the second position.

As a result, the total area of the portions functioning as the active electrodes per unit area can be increased. Hence electric power energy transferred per unit area can be increased.

### OTHER EMBODIMENTS

While the above embodiments have been described in connection with the case where the recess and the projection have the cylindrical, semispherical, or conical shape, the present invention is not limited to those embodiments. The recess and the projection may have another shape, e.g., a rectangular-columnar shape or a pyramidal shape insofar as the recess and the projection can be fitted to each other. In such a modification, the active electrode and the passive electrode may be arranged on the basis of the technical concept described in any of the above embodiments.

While the elastic member or the spring is used as the biasing means in the above-described embodiments, the present invention is not limited to those embodiments. For instance, a repulsive force between two magnets may be utilized as the biasing means.

### REFERENCE SIGNS LIST

1, 201, 301, 401, 501, 601, 701, 801, 901, 1001 wireless power sending device
1A casing
1B placing surface
1a recess
1f upper side portion
1g insulator
1u lower side portion
2, 202, 302, 402, 502, 602, 702, 802, 902 wireless power receiving device
2A casing
2u lower side portion
2a projection
2b insulator
11 AC/DC converter
12 power sending module
12a protection circuit
12b inverter
12c control circuit
21 step-up unit
30 power sending device-side electrode portion
31A power sending device-side active electrode
31P power sending device-side passive electrode
32 spring
40 power receiving device-side electrode portion
41A, 941A power receiving device-side active electrode
41P, 941P power receiving device-side passive electrode
43 step-down unit
44 power receiving module
51 active wiring line
52 passive wiring line
61 battery
62 load circuit
901f upper side portion
901s support portion
901u lower side portion
960 elastic member
960a protruding portion
971 movable electrode
971f insulator
972 floating electrode
973 active wiring line
975 passive wiring line
981 insulator
1074 floating electrode

1. A wireless power sending device that transfers electric power to a wireless power receiving device by electric-field coupling, the wireless power sending device comprising:
a casing having surface;
a plurality of movable electrodes disposed in the surface of the casing in a distributed arrangement and configured to move between a first position and a second position in a direction substantially perpendicular to the surface of the casing; and
a power supply unit that outputs a first potential and a second potential having a larger absolute value than the first potential, wherein the second potential is applied to at least one of the movable electrodes when the at least one movable electrode is in the second position.

2. The wireless power sending device according to claim 1, wherein the at least one movable electrode is moved to the second position when the wireless power receiving device is placed on the surface of the casing and contacts the at least one movable electrode.

3. The wireless power sending device according to claim 1, further comprising a plurality of biasing mechanisms that bias the plurality of movable electrode, respectively, to the first position when the wireless power receiving device is not placed on the surface of the casing.

4. The wireless power sending device according to claim 1, wherein the surface of the casing comprises a plurality of recesses and the plurality of movable electrodes are disposed in the plurality of recesses, respectively.

5. The wireless power sending device according to claim 1, further comprising a fixed electrode, wherein the power supply unit further outputs the first potential to the fixed electrode.

6. The wireless power sending device according to claim 5, wherein the fixed electrode is disposed adjacent to a surface of the plurality of recess of the casing and/or a surrounding portion thereof.

7. The wireless power sending device according to claim 1, wherein the power supply unit applies the first potential to each of the plurality of movable electrodes when the plurality of movable electrodes are in the first position.

8. The wireless power sending device according to claim 7, wherein the power supply unit outputs a ground potential as the first potential and a predetermined potential, which is higher than the ground potential, as the second potential.

9. The wireless power sending device according to claim 7, wherein a conductor is disposed between a region of the surface where the movable electrode is disposed, and wherein the movable electrode contacts the conductor when the movable electrode is in the second position.

10. A wireless power receiving device that receives electric power from a wireless power sending device by electric-field coupling, the wireless power receiving device comprising:
a casing having a surface with at least one projection extending therefrom in a distributed arrangement; and
a first electrode and a second electrode that collectively receive the electric power from the wireless power sending device by electric-field coupling,
wherein the first electrode is disposed in a portion of the projection.

10. The wireless power receiving device according to claim 9, wherein the second electrode is disposed in the surface of the casing at a position other than the portion of the projection wherein the first electrode is disposed.

11. The wireless power receiving device according to claim 10, wherein the second electrode is disposed in a portion of the casing other than the projection.

12. A wireless power transfer system including a wireless power sending device and a wireless power receiving device that receives electric power from the wireless power sending device by electric-field coupling, the wireless power transfer system comprising:
a wireless power sending device including:
a casing having surface,
a plurality of movable electrodes disposed in the surface of the casing in a distributed arrangement and configured to move between a first position and a second position in a direction substantially perpendicular to the surface of the casing, and
a power supply unit that outputs a first potential and a second potential having a larger absolute value than the first potential; and
a wireless power receiving device including:
a casing having a surface with at least one projection extending therefrom in a distributed arrangement and
a first electrode disposed in a portion of the projection, and
and a second electrode,
wherein, when the wireless power receiving device is placed on the surface of the casing of the wireless power sending device, the at least one projection displaces at least one movable electrode of the plurality of movable electrodes, respectively, to the second position and the power supply unit applies the second potential to the displaced at least one movable electrode in the second position.

13. The wireless power transfer system according to claim 12, wherein the wireless power sending device further comprises a plurality of biasing mechanisms that bias the plurality of movable electrode, respectively, to the first position when the wireless power receiving device is not placed on the surface of the casing.

14. The wireless power transfer system according to claim 12, wherein the surface of the casing of wireless power sending device comprises a plurality of recesses and the plurality of movable electrodes are disposed in the plurality of recesses, respectively.

15. The wireless power transfer system according to claim 14, wherein the at least one projection comprises a shape that fits into at least one recess of the plurality recesses, and when the at least one projection is inserted into the at least one recess, the respective movable electrode in the at least one recess is displaced to the second position and the power supply unit applies the second potential to the movable electrode in the second position.

16. The wireless power transfer system according to claim 12, wherein the wireless power sending device further comprises a fixed electrode, wherein the power supply unit further outputs the first potential to the fixed electrode.

17. The wireless power transfer system according to claim 16, wherein the fixed electrode is disposed adjacent to a surface of the plurality of recess of the casing and/or a surrounding portion thereof.

18. The wireless power transfer system according to claim 12, wherein the power supply unit of the wireless power sending device applies the first potential to each of the plurality of movable electrodes when the plurality of movable electrodes are in the first position.

19. The wireless power transfer system according to claim 18, wherein the power supply unit outputs a ground potential as the first potential and a predetermined potential, which is higher than the ground potential, as the second potential.

20. The wireless power transfer system according to claim 18, wherein a conductor is disposed in the wireless power sending between a region of the surface where the movable electrode is disposed, and wherein the movable electrode contacts the conductor when the movable electrode is in the second position.
